(19) United States
(12) Patent Application Publication
(10) Pub. No.: US 2024/0411579 A1
(43) Pub. Date: Dec. 12, 2024

(54) METADATA PARTITIONING ACROSS VIRTUAL PROCESSORS

(71) Applicant: HEWLETT PACKARD ENTERPRISE DEVELOPMENT LP, Spring, TX (US)

(72) Inventors: Vinay Devadas, San Jose, CA (US); Srikant Varadan, Fremont, CA (US); Christopher Joseph Corsi, Wake Forest, NC (US); Shrikant Pramod Mether, San Jose, CA (US)

(21) Appl. No.: 18/332,828

(22) Filed: Jun. 12, 2023

(51) Int. Cl. G06F 9/455

(52) U.S. Cl. CPC G06F 9/45558; G06F 2009/4557; G06F 2009/45583

(57) ABSTRACT

In some examples, a system creates a partition map that maps partitions of a data bucket to respective virtual processors executed in a cluster of computer nodes. Responsive to a request to access a data object in the data bucket, the system identifies which partition contains metadata for the data object based on a key associated with the data object, and identifies, based on the identified partition and using the partition map, a virtual processor that has the metadata for the data object. Responsive to a migration of a first virtual processor from a first to a second computer node, the system updates a virtual processor-computer node map that maps the respective virtual processors to corresponding computer nodes of the cluster of computer nodes, where the partition map remains unchanged in response to the migration of the first virtual processor from the first computer node to the second computer node.

### BACKGROUND

A storage arrangement can include a cluster of computer nodes that manage access of data in a shared storage system that is shared by the cluster of computer nodes. Each computer node of the cluster of computer nodes can execute one or more virtual processors, with each virtual processor managing access to a respective data portion in the shared storage system.

### BRIEF DESCRIPTION OF THE DRAWINGS

Some implementations of the present disclosure are described with respect to the following figures.

FIG. 1 is a block diagram of an arrangement that includes a cluster of computer nodes, a shared storage system, and requester devices, according to some examples.

FIGS. 2A and 2B are block diagrams of partitions in respective virtual processors, according to some examples.

FIG. 3 is a flow diagram of a write operation according to some examples.

FIG. 4 is a block diagram of configuration information specifying prefix lengths for respective data buckets, according to some examples.

FIG. 5 is a block diagram of a storage medium storing machine-readable instructions according to some examples.

FIG. 6 is a block diagram of a system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A “virtual processor” can refer to a computing entity implemented with machine-readable instructions that are executable on a computer node. By managing access of different data portions using respective different virtual processors executed in a cluster of computer nodes, data throughput can be improved when the virtual processors access data in parallel from a shared storage system. A “shared” storage system is a storage system that is shared (i.e., accessible) by any computer node of the cluster of computer nodes.

A data access request (write request or read request) can be received at a given computer node of the cluster of computer nodes. A virtual processor in the given computer node can be assigned to handle the data access request. The virtual processor assigned to handle the data access request may be referred to as a “source virtual processor” with respect to the data access request. In some examples, the source virtual processor may not be the virtual processor that “owns” (i.e., manages access and/or updates to) metadata for the data that is the subject of the data access request. The virtual processor that owns metadata for data that is the subject of a given data access request may be referred to as a “metadata virtual processor” with respect to the given data access request. A virtual processor may also “own” a data object; such a virtual processor is responsible for managing the access and/or updates of the data object.

To process a data access request (such as a request to access a data object), the source virtual processor determines which virtual processor is the metadata virtual processor, and obtains the metadata from the metadata virtual processor. An example of the metadata may include a list of chunk identifiers of chunks that make up the data object. The list of chunk identifiers can be used by the source virtual processor to retrieve the chunks of the data object. Another example of the metadata can include a version of the data object.

For load balancing and improved throughput, metadata for respective data objects can be partitioned into multiple partitions that are spread across multiple virtual processors executing in a cluster of computer nodes. Each computer node can execute one or more virtual processors, and each virtual processor may include one or more partitions. A virtual processor “including” a partition can refer to the virtual processor owning a portion of the metadata (referred to as “metadata portion”) in the partition.

For load balancing reasons and to address faults or failures in computer nodes of the cluster of computer nodes, a virtual processor may be migrated from a source computer node to a target computer node. However, virtual processor migration can lead to processing overhead related to maintaining associations of metadata portions with respective virtual processors. An association between a metadata portion and a given virtual processor can be represented by mapping information. If the associations between metadata portions and virtual processors are not properly maintained in response to migrations of virtual processors, then source virtual processors may have difficulty finding metadata virtual processors when handling incoming data access requests.

Also, in examples where data is stored in the shared storage system in the form of data buckets, a further challenge relates to how metadata for the data buckets are sharded across the cluster of computer nodes as the cluster changes over time (such as due to additions of computer nodes to the cluster).

In accordance with some implementations of the present disclosure, a mapping scheme is provided that uses a partition map and a virtual processor-computer node (VP-CN) map. The partition map associates (maps) partitions (that include metadata portions) to respective virtual processors. The VP-CN map associates (maps) virtual processors to respective computer nodes of the cluster of computer nodes. When a virtual processor is migrated between computer nodes, the VP-CN node map is updated, but the partition map does not change. As a result, requests for data objects that have keys that map to a given virtual processor would continue to map to the given virtual processor after the migration of the given virtual processor between different computer nodes. The static nature of the partition map in the context of virtual processor migrations allows for a system including the cluster of computer nodes to deterministically map metadata of data objects to virtual processors.

In addition, data buckets can be received at different times. A first data bucket may be generated or received when the cluster of computer nodes has a first quantity of computer nodes. Later, one or more computer nodes may be added to the cluster. Even though the cluster of computer nodes has been expanded, the partition map and the VP-CN node map for the first data bucket are not changed, which avoids the burden associated with having to update mappings as the cluster of computer nodes expands. If a second data bucket is generated or received after the expansion of the cluster of computer nodes, a partition map may be created for the second data bucket that make use of the increased quantity of computer nodes. Note that there may be one partition map per data bucket (so that there are multiple partition maps for respective data buckets). However, there is one VP-CN node map that is common for multiple data buckets.

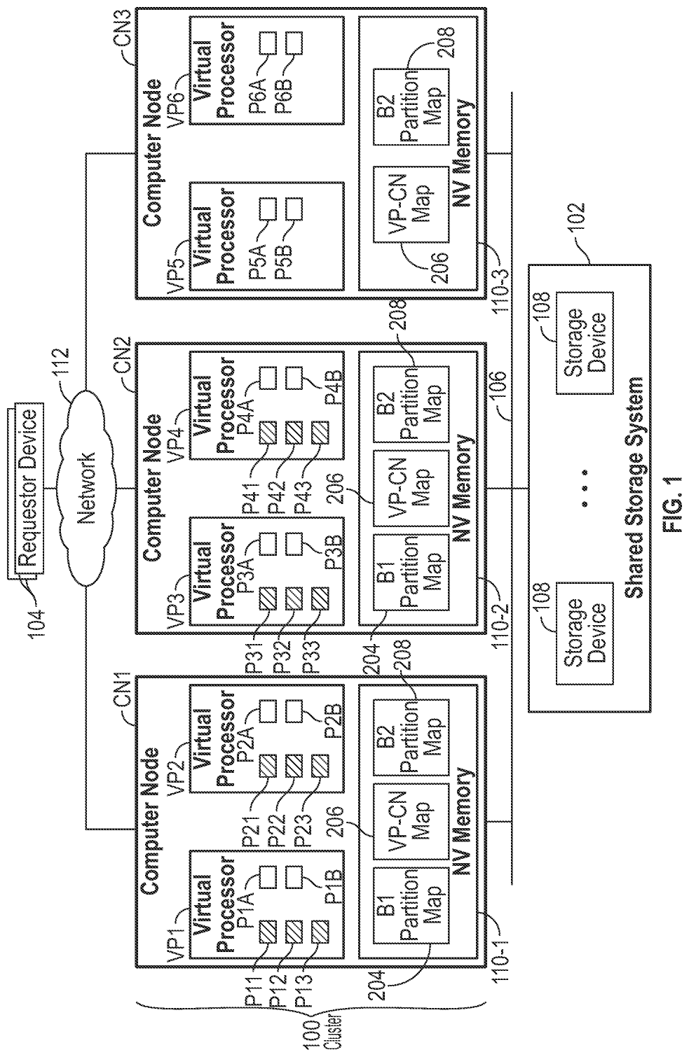

FIG. 1 is a block diagram of an example arrangement that includes a cluster 100 of computer nodes CN1, CN2, and CN3. Although three computer nodes are shown in FIG. 1, in other examples, the cluster 100 can include less than three or more than three computer nodes. A “computer node” can refer to a physical node that includes a processing resource as well as other resources (e.g., communication resources and memory resources) that can perform various tasks. A “processing resource” can include one or more hardware processing circuits which can include any or some combination of a microprocessor, a core of a multi-core microprocessor, a microcontroller, a programmable integrated circuit, a programmable gate array, or another hardware processing circuit. A “communication resource” can include a communication interface (including communication hardware such as a transceiver and any related machine-readable instructions). A “memory resource” can include a memory implemented with a collection of one or more memory devices.

The cluster 100 of computer nodes is able to manage the access of data stored in a shared storage system 102 in response to data access requests received over a network 112 from requester devices 104. As used here, a “requester device” can refer to any electronic device that is able to send a request to access data (read data or write data). Examples of electronic devices include any or some combination of the following: desktop computers, notebook computers, tablet computers, server computers, game appliances, Internet-of-Things (IoT) devices, vehicles, household appliances, and so forth. Examples of the network 112 can include any or some combination of the following: a storage area network (SAN), a local area network (LAN), a wide area network (WAN), and so forth.

The shared storage system 102 is accessible by any of the computer nodes CN1 to CN3 over a communication link 106 between the cluster 100 of computer nodes and the shared storage system 102. The shared storage system 102 is implemented using a collection of storage devices 108. As used here, a “collection” of items can refer to a single item or to multiple items. Thus, the collection of storage devices 108 can include a single storage device or multiple storage devices. Examples of storage devices can include any or some combination of the following: disk-based storage devices, solid state drives, and so forth.

The requester devices 104 can send data access requests to any of the computer nodes CN1 to CN3 over the network 112. Each computer node executes a collection of virtual processors (a single virtual processor or multiple virtual processors). A virtual processor is executed by a processing resource of a computer node.

In the example of FIG. 1, the computer node CN1 includes virtual processors VP1 and VP2, the computer node CN2 includes virtual processors VP3 and VP4, and the computer node CN3 includes virtual processors VP5 and VP6. Although FIG. 1 shows two virtual processors in each computer node, in other examples, a computer node may include a different number (e.g., 1 or more than 2) of virtual processors. Communications among the virtual processors VP1, VP2, VP3, VP4, VP5, and VP6 can occur over a communication link between the virtual processors, such as an inter-process link.

Virtual processors can also be migrated between computer nodes. For example, to achieve load balancing or for fault tolerance or recovery, a first virtual processor may be migrated from a current (source) computer node to a destination computer node. Once migrated, the first virtual processor executes at the destination computer node.

In some examples, data to be stored in the shared storage system 102 by virtual processors can be part of data buckets. A data bucket can refer to any type of container that includes a collection of data objects (a single data object or multiple data objects). A specific example of a data bucket is an S3 bucket in an Amazon cloud storage. In other examples, other types of data buckets can be employed.

A data object can be divided into a collection of data chunks (a single data chunk or multiple data chunks). Each data chunk (or more simply “chunk”) has a specified size (a static size or a size that can dynamically change). The storage locations of the chunks are storage locations in the shared storage system 102.

Each of the virtual processors VP1 to VP6 may maintain respective metadata associated with data objects stored or to be stored in the shared storage system 102. In some examples, the metadata can include data object metadata such as a list of chunk identifiers (IDs) that identify chunks of a data object, and a virtual processor ID that identifies a virtual processor. The list of chunk IDs can include a single chunk ID or multiple chunk IDs. The data object metadata can further include a version ID that represents a version of a data object. As a data object is modified by write request(s), corresponding different versions of the data object are created (and identified by respective version IDs). As used here, an “ID” can refer to any information (e.g., a name, a string, etc.) that can be used to distinguish one item from another item (e.g., distinguish between chunks, or distinguish between data objects, or distinguish between versions of a data object, or distinguish between virtual processors, and so forth).

The metadata may further include storage location metadata representing storage locations of chunks of data objects in the shared storage system 102. For example, the storage location metadata can include any or some combination of the following: an offset, a storage address, a block number, and so forth.

The metadata may also include commit metadata maintained by a metadata virtual processor during write operations and read operations. The commit metadata indicates whether a write of a subject data object is in progress (e.g., at a virtual processor that is assigned to handle the write) or a write of the subject data object is no longer in progress (i.e., a write of the subject data object is complete). Note that a write of the subject data object is complete if the subject data object has been written to either a write buffer (not shown) or the shared storage system 102. A write buffer can be part of an NV memory (e.g., any of 110-1 to 110-3) and is associated with a respective virtual processor for caching write data.

In other examples, additional or alternative metadata may be employed.

As noted above, metadata can be partitioned into multiple partitions that are spread across multiple virtual processors executing in the cluster 100 of computer nodes. Each virtual processor may include one or more partitions. A virtual processor “including” a partition can refer to the virtual processor owning a metadata portion in the partition.

As shown in FIG. 1, the virtual processor VP1 includes partitions P11, P12, P13 for data bucket B1, and includes partitions P1A, P1B for data bucket B2. The partitions for the data bucket B1 are shaded, while the partitions for the data bucket B2 are not shaded in FIG. 1. Similarly, the virtual processor VP2 includes partitions P21, P22, P23 for data bucket B1, and includes partitions P2A, P2B for data bucket B2, the virtual processor VP3 includes partitions P31, P32, P33 for data bucket B1, and includes partitions P3A, P3B for data bucket B2, the virtual processor VP4 includes partitions P41, P42, P43 for data bucket B1, and includes partitions P4A, P4B for data bucket B2, the virtual processor VP5 includes partitions P51, P52, P53 for data bucket B1, and includes partitions P5A, P5B for data bucket B2, and the virtual processor VP6 includes partitions P61, P62, P63 for data bucket B1, and includes partitions P6A, P6B for data bucket B2.

Even though the partitions are shown as being inside respective virtual processors in FIG. 1, note that the metadata portions of the partitions are stored in respective non-volatile (NV) memories 110-1, 110-2, and 110-3 of the corresponding computer nodes CN1, CN2, and CN3. An NV memory is a memory that can persistently store data, such that data stored in the NV memory is not lost when power is removed from the NV memory or from a computer node in which the NV memory is located. An NV memory can include a collection of NV memory devices (a single NV memory device or multiple NV memory devices), such as flash memory devices and/or other types of NV memory devices.

Also, although each virtual processor is depicted as including a specific quantity of partitions, in other examples, a virtual processor can include a different quantity of partitions for any given data bucket.

Each virtual processor is responsible for managing respective metadata of one or more partitions. In an example, there are M (M≥2) partitions and P (P≥2) virtual processors. In such an example, each virtual processor of the P virtual processors is responsible for managing metadata of M/P partitions.

A partition is identified by a Partition ID. In some examples, a Partition ID is based on applying a hash function (e.g., a cryptographic hash function or another type of hash function) on information (key) associated with a data object. In some examples, the key associated with the data object on which the hash function is applied includes a Bucket ID identifying the data bucket of which the data object is part, and an Object ID that identifies the data object. The hash function applied on the key associated with the data object produces a hash value that is the Partition ID or from which the Partition ID is derived.

For example, a hash value (Hash-Value) is computed as follows:

$$Hash - Value = Hash ( F ( Request . key ) ) , \qquad ( Eq . 1 )$$

where F(x) is a transformation applied on x (in this case a transformation applied on Request.key), Hash( ) is a hash function, and Request.key includes the Bucket ID and the Object ID of a data access request (a read request or write request). The transformation can be a concatenation operation of Bucket ID and Object ID, for example.

The Partition ID is computed based on the Hash-Value as follows:

$$Partition ID = H ash - Value \% \#Partitions , \qquad ( Eq . 2 )$$

where % is a modulus operation, and #Partitions is a constant (which can be a configured value) that represents how many partitions are to be divided across a cluster of computer nodes. The modulus operation computes the remainder after dividing Hash-Value by #Partitions.

As each data bucket is created, the metadata for each data bucket is sharded across multiple partitions. A given partition defines a subset of the object key-space for a specific data bucket and maps to one virtual processor. The object key-space for a data bucket refers to the possible range of values associated with the key for data objects in the data bucket, such as by Hash-Value-Range above. The entire object key-space can be uniformly distributed among the partitions, which can lead to equal size partitions. A last partition may be larger or smaller if the object key-space is not exactly divisible by the number of partitions.

As shown in FIG. 1, multiple partitions of the same bucket can potentially be included in the same virtual processor. In some examples, every data object maps to one partition and all data objects in a partition belong to the same data bucket. Further, in some examples, all versions of a given data object map to the same partition; in other words, the hashing of keys of data objects to map to partitions is version agnostic.

In some examples, the quantity of partitions for a data bucket is a configurable constant (e.g., #Partitions in Eq. 2 above) across all buckets-in other words, each data bucket of multiple data buckets to be stored in the shared storage system 102 can have a static quantity of partitions. In the example of FIG. 1, the configurable constant is 12 (in a different example, a different configurable constant of partitions can be used). For data bucket B1, the 12 partitions are divided across 4 virtual processors VP1 to VP4 such that each virtual processor (of VP1 to VP4) includes three partitions for bucket B1. For data bucket B2, the 12 partitions are divided across 6 virtual processors VP1 to VP6 such that each virtual processor (of VP1 to VP6) includes two partitions for bucket B2.

For an even distribution of partitions across virtual processors, the configurable constant (e.g., #Partitions in Eq. 2) may be a highly composite number with a relatively large quantity of divisors. For example, the number 48 is divisible by the following divisors: 1, 2, 3, 4, 6, 8, 12, 16, 24, 48. When a data bucket is created, the data bucket is associated with the static quantity of partitions, which are spread out as uniformly as possible across all available virtual processors in the cluster 100 at the time the data bucket is created.

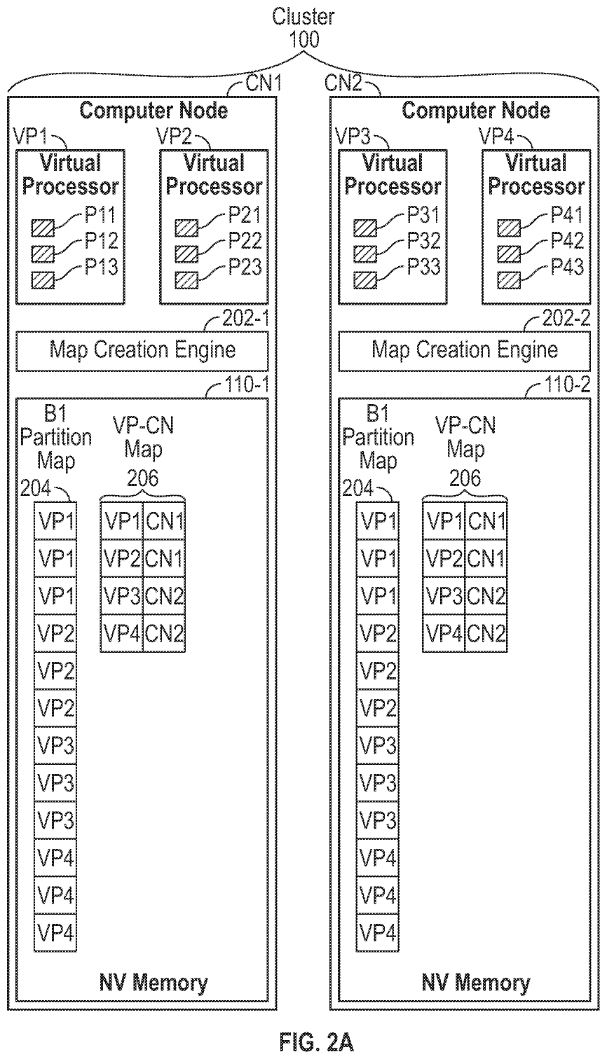

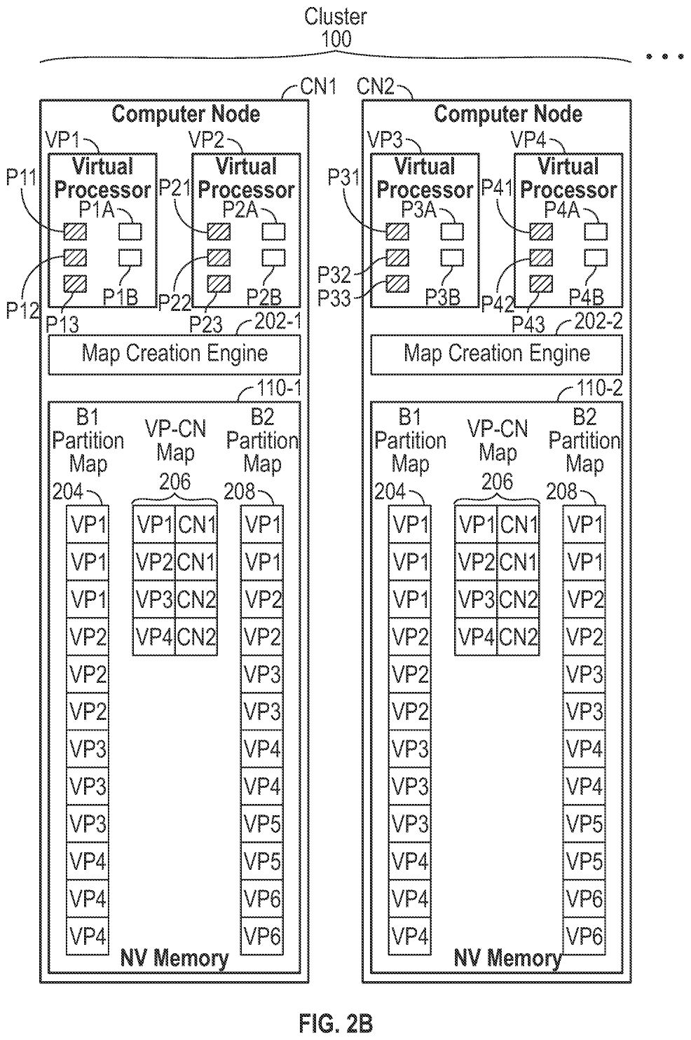

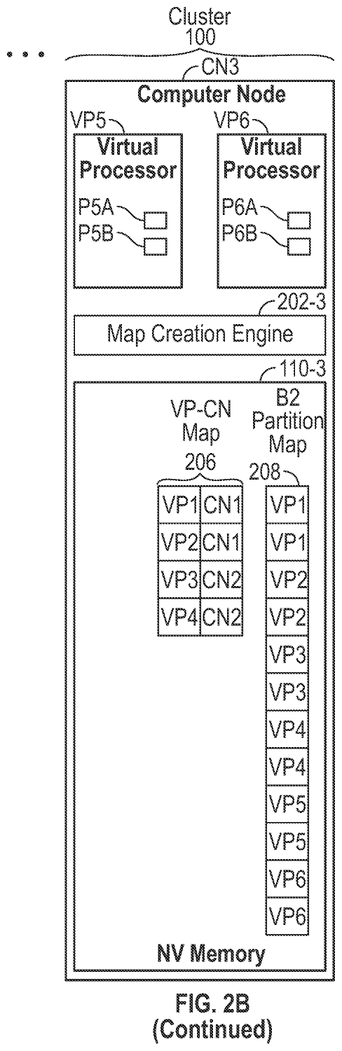

FIG. 1 further depicts partition maps and VP-CN maps stored in the NV memories 110-1 to 110-3, which are discussed below in conjunction with FIGS. 2A and 2B.

FIG. 2A shows an example arrangement of the cluster 100 of computer nodes at a first point in time (T1). At this first point in time, the cluster 100 of computer nodes includes two computer nodes CN1 and CN2. The computer node CN1 executes the virtual processors VP1, VP2, and the computer node CN2 executes the virtual processors VP3, VP4. Note that at time T1, the computer node CN3 is not yet present in the cluster 100.

Data bucket B1 is created when the cluster 100 is configured with the computer nodes CN1 and CN2 at time T1. In some examples, the creation of data bucket B1 is triggered by a user, such as at a requester device 104. In other examples, another entity (a program or a machine) can trigger the creation of data bucket B1. Creation of a data bucket can be triggered in response to a request or any other type of input from an entity (user, program, or machine).

In some examples, the request to create data bucket B1 can be received at any of the computer nodes of the cluster 100. The computer node that received the request creates a partition map. Each computer node includes a map creation engine that creates the partition map. In the example of FIG. 2A, the computer nodes CN1 and CN2 include respective map creation engines 202-1 and 202-2.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

It is assumed that the computer node CN1 received the request to create data bucket B1. In this example, the map creation engine 202-1 responds to the request to create data bucket B1 by creating a B1 partition map 204 that maps partitions containing metadata for data objects of data bucket B1 to respective virtual processors. In the example of FIG. 2A, it is assumed that metadata for a data bucket is sharded across 12 partitions (in other words, #Partitions=12). As a result, since there are four virtual processors VP1, VP2, VP3, and VP4, three partitions are mapped to each virtual processor.

The B1 partition map 204 includes a number of entries that is equal to #Partitions. If #Partitions is 12, then the B1 partition map 204 includes 12 entries. Each entry of the 12 entries corresponds to a respective partition of the 12 partitions. Thus, the first entry of the B1 partition map 204 corresponds to partition P11, the second entry of the B1 partition map 204 corresponds to partition P12, the third entry of the B1 partition map 204 corresponds to partition P13, the fourth entry of the B1 partition map 204 corresponds to partition P21, and so forth. Each entry of the B1 partition map 204 contains an identifier of a virtual processor that is associated with the corresponding partition. Thus, in the example of FIG. 2A, the 12 entries associate partitions to virtual processors as follows: the first entry maps P11 to VP1, the second entry maps P12 to VP1, the third entry maps P13 to VP1, the fourth entry maps P21 to VP2, the fifth entry maps P22 to VP2, the sixth entry maps P23 to VP2, the seventh entry maps P31 to VP3, the eighth entry maps P32 to VP3, the ninth entry maps P33 to VP3, the tenth entry maps P41 to VP4, the eleventh entry maps P42 to VP4, and the twelfth entry maps P43 to VP4.

Once created by the map creation engine 202-1, the B1 partition map 204 can be stored (persisted) in the shared storage system 102 by the computer node CN1 that processed the request to create data bucket B1. The other computer nodes, such as CN2, can read the B1 partition map 204 from the shared storage system 102 (such as while processing write and read requests) and cache a copy of the B1 partition map 204 in the NV memory 110-2.

Note that each computer node CN1 or CN2 also includes a VP-CN map 206 that is created by a map creation engine (same as or different from the map creation engine used to create a partition map). The VP-CN map 206 associates virtual processors to computer nodes that are present in the cluster 100 at time T1. The first entry of the VP-CN map 206 maps VP1 to CN1, the second entry of the VP-CN map 206 maps VP2 to CN1, the third entry of the VP-CN map 206 maps VP3 to CN2, and the fourth entry of the VP-CN map 206 maps VP4 to CN2.

If the configuration of the cluster 100 is changed (by adding or removing computer nodes), then the VP-CN map 206 can be modified to change the mapping of virtual processors and computer nodes.

In further examples, the map creation engine(s) to create partition maps and/or a VP-CN maps can be in a computer system separate from the cluster 100 of the computer nodes.

FIG. 2B shows an arrangement of the cluster 100 of computer nodes at a later point in time (T2). At time T2, the third computer node CN3 has been added to the cluster 100 of computer nodes. The third computer node CN3 executes the virtual processors VP5 and VP6, and includes a map creation engine 202-3.

After the third computer node CN3 has been added, data bucket B2 is created. The metadata for the data objects of data bucket B2 is divided into 12 partitions (#Partitions=12) across the virtual processors VP1 to VP6 of the three computer nodes CN1, CN2, and CN3. As a result, two partitions are included in each virtual processor for data bucket B2.

In response to the creation of data bucket B2, a map creation engine (any of 202-1, 202-2, and 202-3 in the computer node that received the request to create data bucket B2) creates a B2 partition map 208. The 12 entries of the B2 partition map 208 correspond to the 12 partitions P1A, P1B, P2A, P2B, P3A, P3B, P4A, P4B, P5A, P5B, P6A, and P6B, respectively. The 12 entries of the B2 partition map 208 associate partitions to virtual processors as follows: the first entry maps P1A to VP1, the second entry maps P1B to VP1, the third entry maps P2A to VP2, the fourth entry maps P2B to VP2, the fifth entry maps P3A to VP3, the sixth entry maps P3B to VP3, the seventh entry maps P4A to VP4, the eighth entry maps P4B to VP4, the ninth entry maps P5A to VP5, the tenth entry maps P5B to VP5, the eleventh entry maps P6A to VP6, and the twelfth entry maps P6B to VP6.

Once created, the B2 partition map 208 can be written by the computer node at which the B2 partition map 208 was created to the shared storage system 102, and the other two computer nodes can read the B2 partition map 208 from the shared storage system 102 to cache respective copies of the B2 partition map 208 in the respective NV memories. Note that each of the computer nodes CN1 and CN2 includes the following maps: the B1 partition map 204, the VP-CN map 206, and the B2 partition map 208. The computer node CN3 includes the VP-CN map 206 and the B2 partition map 208, but does not include the B1 partition map 204.

In some examples, the partition maps (204 and 208) once assigned can remain static as the cluster 100 of computer nodes is expanded by adding more computer nodes. The partition maps 204 and 208 and the VP-CN map 206 may be stored in a repository (e.g., in the shared storage system), with copies of the maps 204, 206, and 208 cached in the computer nodes CN1, CN2, and CN3, such as in the respective NV memories 110-1, 110-2, and 110-3.

### Write Operation

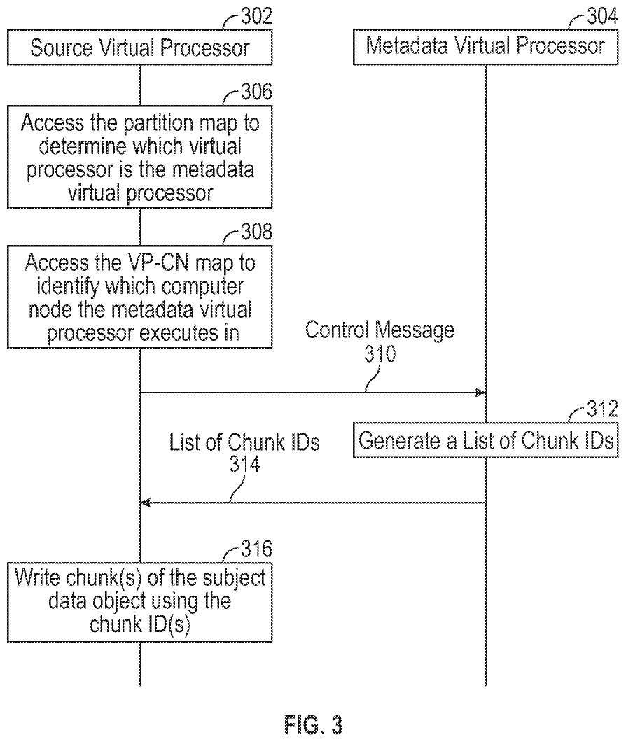

FIG. 3 is a flow diagram of an example a write operation performed in response to an incoming write request received by a computer node from a requester device 104. For simplicity, the flow depicted in FIG. 3 omits some tasks that may be performed as part of the write operation.

The computer node that received the incoming write request is referred to as the “receiving computer node.” In examples where the receiving computer node executes multiple virtual processors, the receiving computer node selects one of the multiple virtual processors as a source virtual processor 302 to handle the incoming write request. The selection can be a random selection process in which the source virtual processor 302 is randomly selected from the multiple virtual processors in the receiving computer node. In another example, the selection process can be based on determining relative loads of the virtual processors in the receiving computer node, and selecting a virtual processor with the least load to be the source virtual processor 302.

In response to the write request, the receiving computer node determines which of the virtual processors VP1 to VP6 in the cluster 100 of computer nodes is a metadata virtual processor 304 for the subject data object of the incoming write request 120. The receiving computer node can apply a hash function or another type of function on a key associated with the subject data object, to produce a Partition ID that identifies the partition that the metadata for the subject data object is part of. The key includes a Bucket ID identifying the data bucket that the subject data object is part of, and an Object ID that identifies the subject data object. Once the Partition ID is obtained, the source virtual processor 302 accesses (at 306) a partition map for the data bucket identified by the Bucket ID to determine which virtual processor (the metadata virtual processor 304) is mapped to the partition identified by the Partition ID. This virtual processor is the metadata virtual processor 304.

The source virtual processor 302 also accesses (at 308) the VP-CN map (e.g., 206) to identify which computer node the metadata virtual processor 304 executes in. The source virtual processor 302 sends (at 310) a control message to the metadata virtual processor 306 in the identified computer node. The control message contains the Bucket ID, Partition ID, Object ID, and Version ID of the subject data object. The control message is to indicate to the metadata virtual processor 306 that the source virtual processor 302 is ready to start the write operation for the incoming write request.

In response to the control message, the metadata virtual processor 306 generates (at 312) a list of chunk IDs that identifies one or more data chunks for the subject data object. The chunk ID(s) generated depend(s) on the size of the subject data object—the size of the subject data object determines how many data chunks are to be divided from the subject data object. The metadata virtual processor 306 sends (at 314) the list of chunk IDs to the source virtual processor 302.

In response to receiving the list of chunk IDs from the metadata virtual processor 306, the source virtual processor 302 writes (at 316) the chunk(s) of the subject data object using the chunk ID(s) included in the list of chunk IDs. The source virtual processor 302 can write the data chunk(s) to a write buffer (not shown) associated with the source virtual processor 302 and/or to the shared storage system 102.

### Rebalancing

Note that rebalancing of partitions across computer nodes may occur if one or more computer nodes are removed from the cluster 100. The partitions of the removed one or more computer nodes can be added to virtual processors of the remaining computer nodes of the cluster 100.

Rebalancing of partitions across computer nodes of the cluster 100 may also occur in response to another condition, such as overloading or a fault of a virtual processor or a computer node. For example, if a given virtual processor is overloaded, then a partition can be moved from the given virtual processor to another virtual processor. Rebalancing one or more partitions from heavily loaded virtual processors to more lightly loaded virtual processors can reduce metadata hot-spots. A metadata hot-spot can occur at a given virtual processor if there is a large number of requests for metadata associated with subject data objects of write requests from other virtual processors to the given virtual processor.

If a virtual processor or a computer node is heavily loaded (due to performing a large quantity of operations as compared to virtual processors on other computer nodes), then one or more partitions of the heavily loaded virtual processor or computer node can be moved to one or more other virtual processors (which can be on the same or a different computer node). Moving a partition from a first virtual processor to a second virtual processor results in the first virtual processor no longer owning the metadata of the partition, and the second virtual processor owning the metadata of the partition.

As an example, in FIG. 1, the partition P11 initially included in the virtual processor VP1 on the computer node CN1 may be moved to the virtual processor VP3 on the computer node CN2. As a result of the movement of the partition P11, the partition map 204 is modified to map P11 to VP2.

The movement of a partition between different computer nodes can be accomplished with reduced overhead since data in data objects does not have to be moved between computer nodes as a result of the movement of the partition. For example, when the partition P11 is moved from the virtual processor VP1 to the virtual processor VP3, the data objects associated with the metadata in the moved partition do not have to be moved between the computer nodes CN1 and CN2. If the data objects associated with the metadata in the moved partition P11 are in the write buffer of the computer node CN1, the data objects can be flushed to the shared storage system 102 (but do not have to be copied to the computer node CN2). If the data objects associated with the metadata in the moved partition P11 are already in the shared storage system 102, then no movement of the data objects occur in response to movement of the partition P11.

In some examples, if the data objects associated with the metadata in the moved partition P11 are arranged in a hierarchical structure, then a root or other higher-level element may be moved from the computer node CN1 to the computer node CN2. An example of such a higher-level element is a superblock, which contains storage locations of the data objects. However, the amount of information in the superblock is much less than the data contained in the data objects referred to by the superblock, so the movement of the superblock between computer nodes has a relatively low overhead in terms of resources used.

Note that rebalancing can also be accomplished by moving a virtual processor (and its included partitions) between different computer nodes. The migration of a given virtual processor from a source computer node to a target computer node can similarly be accomplished without moving data of associated data objects between the source and target computer nodes, although superblocks or other higher-level elements may be moved.

### Prefix-Based Hashing

In some examples, prefix-based hashing is applied on a prefix of a key of a data access request to produce a hash value from which a Partition ID is derived. In such examples, Eq. 1 is modified to produce a hash value (Hash-Value) as follows:

$$Hash - Value = Hash ( Prefix of Request . key ) , \qquad ( Eq . 3 )$$

where Prefix of Request.key represents the prefix of the key.

The prefix has a specified prefix length. In some examples, different data buckets can be associated with respective prefix lengths, at least some of which may be different from one another.

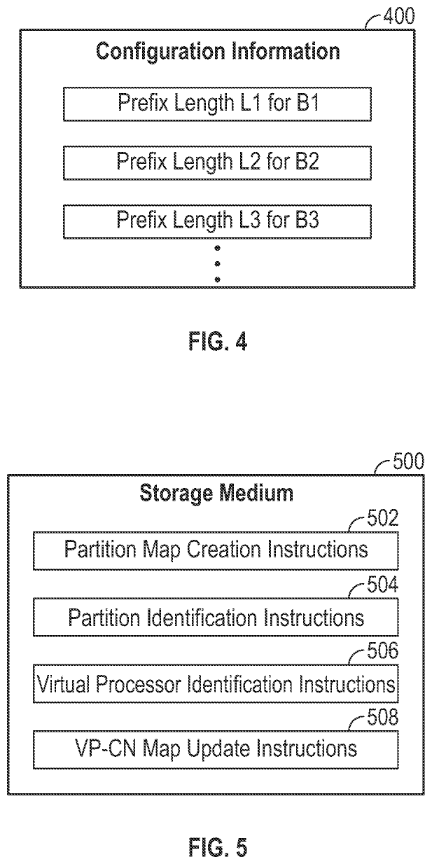

For example, FIG. 4 shows an example in which a prefix length L1 is specified for data bucket B1, a prefix length L2 is specified for data bucket B2, a prefix length L3 is specified for data bucket B3, and so forth. The prefix lengths L1, L2, L3, and so forth, can be stored as part of configuration information 400 that is accessible by virtual processors in the cluster 100 of computer nodes. The configuration information 400 may be stored in an NV memory of each computer node, for example. In some examples, a prefix length for a data bucket can be expressed as a percentage of the full key length (the full length of the key including the Bucket ID and Object ID). For example, L1 may be set at 100%, L2 may be set at 90%, L3 may be set at 75%, and so forth. In other examples, a prefix length can be expressed as a quantity of bits of the key on which the hash function is to be applied.

More generally, each prefix length in the configuration information 400 is specified for a respective collection of data buckets (a single data bucket or multiple data buckets).

The ability to specify different prefix lengths for different data buckets (or more generally different collections of data buckets) enhances flexibility in how metadata for the different data buckets are sharded across virtual processors in the cluster 100 of computer nodes. For example, the different data buckets (or collections of data buckets) may be associated with different applications.

The computation of hash values from which Partition IDs are determined based on prefixes of keys (rather than the entirety of the keys) can allow for greater efficiency when performing range queries with respect to data objects. A “range query” is a query for a collection of data objects with keys within a specified range.

In an example, it is assumed that a given data bucket contains R (R≥2) data objects, where the keys of each of the data objects in the given data bucket start with “/myprefix/”, which is a combination of the Bucket ID and a portion (less than the entirety of the Object ID of a data object in the given data bucket. In this example, data object 1 has key “/myprefix/foo”, data object 2 has key “/myprefix/bar, . . . , and data object N has key “/myprefix/foobar”.

Further, assume the prefix length for the given data bucket specified by the configuration information 400 is the length of the string “/myprefix/”. As a result, when computing the hash value according to Eq. 3 based on the key of each respective data object in the given data bucket, the hash function is applied on the same string “/myprefix/” of each key of the respective data object. The same Partition ID will be generated for each data object of the given data bucket, so that the metadata for all of the data objects in the given data bucket will end up in the same partition,

Subsequently, if a user or another entity submits a range query (such as from a requester device 104 of FIG. 1), the range query can be performed by just one virtual processor including the partition to which all of the data objects of given data bucket map. As an example, the range query can seek to retrieve or identify data objects of the given data bucket within a range of keys, such as between Key A and Key B. This range query can be performed at the virtual processor including the partition to which all of the data objects of given data bucket map, rather than being performed by multiple virtual processors across multiple computer nodes. As a result, the range query can be more efficiently performed, since data objects would not have to be exchanged between virtual processors to be aggregated before returning the result to the requester.

FIG. 5 is a block diagram of a non-transitory machine-readable or computer-readable storage medium 500 storing machine-readable instructions that upon execution cause a processing system to perform various tasks. The processing system can include any one or more of the computer nodes shown in FIG. 1, and/or any other computer system.

The machine-readable instructions include partition map creation instructions 502 to create a partition map that maps partitions of a data bucket to respective virtual processors executed in a cluster of computer nodes that are coupled to a shared storage system to store data of the data bucket. The portions of metadata for the data bucket are divided across the partitions. The partition map creation instructions 502 can include instructions of any or some combination of the map creation engines 202-1 to 202-3 of FIGS. 2A and 2B.

The machine-readable instructions include partition identification instructions 504 to, responsive to a request to access a data object in the data bucket, identify which partition of the partitions contains metadata for the data object based on a key associated with the data object. In some examples, the identification of the partition is based on applying a function (e.g., a hash function such as in Eq. 1 or 3) on a key associated with the request to access the data object.

The function can be applied on a first portion of the key associated with the data object to obtain a value, which is used to identify the partition that contains the metadata for the data object. In some examples, the first portion of the key is a prefix of the key, where the prefix of the key is less than an entirety of the key.

The machine-readable instructions further include virtual processor identification instructions 506 to identify, based on the identified partition and using the partition map, a virtual processor that has the metadata for the data object. The partition map associates the identified partition with the virtual processor.

The machine-readable instructions further include VP-CN map update instructions 508 to, responsive to a migration of a first virtual processor from a first computer node to a second computer node of the cluster of computer nodes, update a VP-CN map that maps the respective virtual processors to corresponding computer nodes of the cluster of computer nodes. Although the VP-CN map is updated, the partition map remains unchanged in response to the migration of the first virtual processor from the first computer node to the second computer node.

In some examples, the migration of the first virtual processor from the first computer node to the second computer node causes migration of one or more portions of the metadata associated with the first virtual processor from the first computer node to the second computer node. In some examples, the migration of the first virtual processor from the first computer node to the second computer node is performed without performing movement of data owned by the first virtual processor between computer nodes of the cluster of computer nodes.

In some examples, prior to the migration of the first virtual processor, a first request for a first data object associated with a first key maps, based on the partition map, to the first virtual processor on the first computer node. After the migration of the first virtual processor, a second request for the first data object associated with the first key maps, based on the partition map, to the first virtual processor on the second computer node.

In some examples, in response to the first request, the machine-readable instructions obtain metadata for the first data object from the first virtual processor on the first computer node, and in response to the second request, the machine-readable instructions obtain the metadata for the first data object from the first virtual processor on the second computer node.

In some examples, different keys associated with respective data objects that share a same prefix map to a same partition, and the machine-readable instructions perform a range query for a range of keys at one or more virtual processors mapped to a partition associated with the range of keys.

In some examples, in response to detecting a metadata hotspot at a given virtual processor, the machine-readable instructions migrate a first partition from the given virtual processor to another virtual processor, and update the partition map in response to the migration of the first partition.

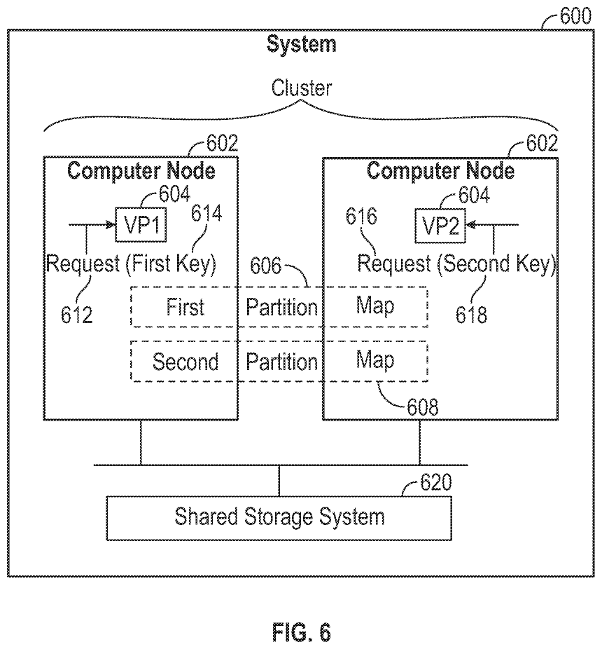

FIG. 6 is a block diagram of a system 600 that includes a cluster of computer nodes 602 to execute a plurality of virtual processors 604. The cluster of computer nodes 602 stores a first partition map 606 that maps partitions of a first data bucket to a first subset of virtual processors, where portions of metadata for the first data bucket are divided across the partitions of the first data bucket. The cluster of computer nodes 602 stores a second partition map 608 that maps partitions of a second data bucket to a second subset of virtual processors, where portions of metadata for the second data bucket are divided across the partitions of the second data bucket.

The system 600 includes a shared storage system 610 accessible by the cluster of computer nodes 602 to store data of the first and second data buckets.

A first virtual processor VP1 in the cluster of computer nodes 602 responds to a request 612 to access a first data object in the first data bucket by identifying a first given partition of the partitions of the first data bucket that contains metadata for the first data object based on a first portion of a first key 614 associated with the first data object. The first virtual processor VP1 identifies, based on the first given partition and using the first partition map 606, a virtual processor that has the metadata for the first data object.

A second virtual processor VP2 in the cluster of computer nodes 602 responds to a request 616 to access a second data object in the second data bucket by identifying a second given partition of the partitions of the second data bucket that contains metadata for the second data object based on a second portion of a second key 618 associated with the second data object. The second portion of the second key 618 is of a different length than the first portion of the first key 614. The second virtual processor VP2 identifies, based on the second given partition and using the second partition map 608, a virtual processor that has the metadata for the second data object.

In some examples, the identifying of the first given partition of the partitions of the first data bucket that contains metadata for the first data object is based on applying a hash function on the first portion of the first key associated with the first data object, and the identifying of the second given partition of the partitions of the second data bucket that contains metadata for the second data object is based on applying the hash function on the second portion of the second key associated with the second data object.

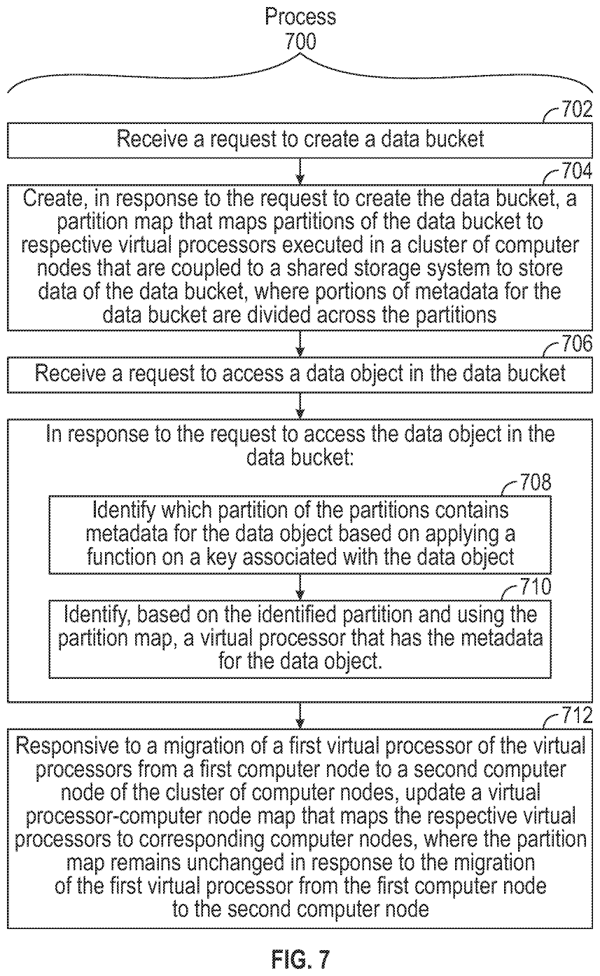

FIG. 7 is a block diagram of a process 700 according to some examples, which may be performed by a system including a hardware processor. The system can include one computer or more than one computer.

The process 700 includes receiving (at 702) a request to create a data bucket. The process 700 includes creating (at 704), in response to the request to create the data bucket, a partition map that maps partitions of the data bucket to respective virtual processors executed in a cluster of computer nodes that are coupled to a shared storage system to store data of the data bucket, where portions of metadata for the data bucket are divided across the partitions.

The process 700 includes receiving (at 706) a request to access a data object in the data bucket. In response to the request to access the data object in the data bucket, the process 700 identifies (at 708) which partition of the partitions contains metadata for the data object based on applying a function on a key associated with the data object, and identifies (at 710), based on the identified partition and using the partition map, a virtual processor that has the metadata for the data object.

Responsive to a migration of a first virtual processor of the virtual processors from a first computer node to a second computer node of the cluster of computer nodes, the process 700 updates (at 712) a virtual processor-computer node map that maps the respective virtual processors to corresponding computer nodes of the cluster of computer nodes, where the partition map remains unchanged in response to the migration of the first virtual processor from the first computer node to the second computer node.

A storage medium (e.g., 500 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a processing system to:
create a partition map that maps partitions of a data bucket to respective virtual processors executed in a cluster of computer nodes that are coupled to a shared storage system to store data of the data bucket, wherein portions of metadata for the data bucket are divided across the partitions;
responsive to a request to access a data object in the data bucket, identify which partition of the partitions contains metadata for the data object based on a key associated with the data object, and identify, based on the identified partition and using the partition map, a virtual processor that has the metadata for the data object; and
responsive to a migration of a first virtual processor of the virtual processors from a first computer node to a second computer node of the cluster of computer nodes, update a virtual processor-computer node map that maps the respective virtual processors to corresponding computer nodes of the cluster of computer nodes,
wherein the partition map remains unchanged in response to the migration of the first virtual processor from the first computer node to the second computer node.

2. The non-transitory machine-readable storage medium of claim 1, wherein the migration of the first virtual processor from the first computer node to the second computer node causes migration of one or more portions of the metadata associated with the first virtual processor from the first computer node to the second computer node.

3. The non-transitory machine-readable storage medium of claim 2, wherein the migration of the first virtual processor from the first computer node to the second computer node is performed without performing movement of data owned by the first virtual processor between computer nodes of the cluster of computer nodes.

4. The non-transitory machine-readable storage medium of claim 1, wherein:
prior to the migration of the first virtual processor, a first request for a first data object associated with a first key maps, based on the partition map, to the first virtual processor on the first computer node, and
after the migration of the first virtual processor, a second request for the first data object associated with the first key maps, based on the partition map, to the first virtual processor on the second computer node.

5. The non-transitory machine-readable storage medium of claim 4, wherein the instructions upon execution cause the processing system to:
in response to the first request, obtain metadata for the first data object from the first virtual processor on the first computer node; and
in response to the second request, obtain the metadata for the first data object from the first virtual processor on the second computer node.

6. The non-transitory machine-readable storage medium of claim 1, wherein the instructions upon execution cause the processing system to:
apply a function on a first portion of the key associated with the data object to obtain a value; and
use the value to identify the partition that contains the metadata for the data object.

7. The non-transitory machine-readable storage medium of claim 6, wherein the first portion of the key is a prefix of the key, the prefix of the key being less than an entirety of the key.

8. The non-transitory machine-readable storage medium of claim 7, wherein the instructions upon execution cause the processing system to:
store configuration information indicating a length of the prefix.

9. The non-transitory machine-readable storage medium of claim 8, wherein the configuration information indicates different lengths of prefixes for different data buckets.

10. The non-transitory machine-readable storage medium of claim 7, wherein different keys associated with respective data objects that share a same prefix map to a same partition of the partitions, and the instructions upon execution cause the processing system to:
perform a range query for a range of keys at one or more virtual processors mapped to a partition associated with the range of keys.

11. The non-transitory machine-readable storage medium of claim 6, wherein the data object is a first data object, the data bucket is a first data bucket, and the instructions upon execution cause the processing system to:
apply a function on a first portion of a key associated with a second data object in a second data bucket to obtain a second value, wherein a length of the first portion of the key associated with the second data object in the second data bucket is different from a length of the first portion of the key associated with the first data object in the first data bucket; and
use the second value to identify another partition that contains metadata for the second data object.

12. The non-transitory machine-readable storage medium of claim 1, wherein the instructions upon execution cause the processing system to:
in response to detecting a metadata hotspot at a given virtual processor, migrate a first partition of the partitions from the given virtual processor to another virtual processor; and
update the partition map in response to the migration of the first partition.

13. The non-transitory machine-readable storage medium of claim 1, wherein the instructions upon execution cause the processing system to:
create the partition map in response to generation or receipt of the data bucket to be stored in the shared storage system.

14. A system comprising:
a cluster of computer nodes to execute a plurality of virtual processors, wherein the cluster of computer nodes is to store:
a first partition map that maps partitions of a first data bucket to a first subset of virtual processors, wherein portions of metadata for the first data bucket are divided across the partitions of the first data bucket, and
a second partition map that maps partitions of a second data bucket to a second subset of virtual processors, wherein portions of metadata for the second data bucket are divided across the partitions of the second data bucket; and
a shared storage system accessible by the cluster of computer nodes to store data of the first and second data buckets,
wherein a first virtual processor in the cluster of computer nodes is to:
responsive to a request to access a first data object in the first data bucket, identify a first given partition of the partitions of the first data bucket that contains metadata for the first data object based on a first portion of a first key associated with the first data object, and
identify, based on the first given partition and using the first partition map, a virtual processor that has the metadata for the first data object,
wherein a second virtual processor in the cluster of computer nodes is to:
responsive to a request to access a second data object in the second data bucket, identify a second given partition of the partitions of the second data bucket that contains metadata for the second data object based on a second portion of a second key associated with the second data object, wherein the second portion of the second key is of a different length than the first portion of the first key, and
identify, based on the second given partition and using the second partition map, a virtual processor that has the metadata for the second data object.

15. The system of claim 14, wherein a first computer node of the cluster of computer nodes is to:
migrate the first virtual processor from the first computer node to a second computer node of the cluster of computer nodes, and
update a virtual processor-computer node map that maps the virtual processors of the first subset of virtual processors to corresponding computer nodes of the cluster of computer nodes,
wherein the first partition map remains unchanged in response to the migration of the first virtual processor from the first computer node to the second computer node.

16. The system of claim 14, wherein a computer node of the cluster of computer nodes is to:
detect a metadata hot-spot at the first virtual processor, and
in response to the metadata hot-spot, move at least one partition from the first virtual processor to another virtual processor.

17. The system of claim 14, wherein the identifying of the first given partition of the partitions of the first data bucket that contains metadata for the first data object is based on applying a hash function on the first portion of the first key associated with the first data object, and
wherein the identifying of the second given partition of the partitions of the second data bucket that contains metadata for the second data object is based on applying the hash function on the second portion of the second key associated with the second data object.

18. The system of claim 17, wherein the first portion of the first key is a first prefix of the first key, and the second portion of the second key is a second prefix of the second key.

19. A method of a system comprising a hardware processor, comprising:
receiving a request to create a data bucket;
in response to the request to create the data bucket, creating a partition map that maps partitions of the data bucket to respective virtual processors executed in a cluster of computer nodes that are coupled to a shared storage system to store data of the data bucket, wherein portions of metadata for the data bucket are divided across the partitions;
receiving a request to access a data object in the data bucket;
in response to the request to access the data object in the data bucket, identifying which partition of the partitions contains metadata for the data object based on applying a function on a key associated with the data object, and identifying, based on the identified partition and using the partition map, a virtual processor that has the metadata for the data object; and
responsive to a migration of a first virtual processor of the virtual processors from a first computer node to a second computer node of the cluster of computer nodes, updating a virtual processor-computer node map that maps the respective virtual processors to corresponding computer nodes of the cluster of computer nodes, wherein the partition map remains unchanged in response to the migration of the first virtual processor from the first computer node to the second computer node.

20. The method of claim 19, further comprising:
accessing configuration information in the cluster of computer nodes to determine a length of a portion of the key on which the function is to be applied.
